(19) United States
(12) Patent Application Publication
(10) Pub. No.: US 2005/0218066 A1
(43) Pub. Date: Oct. 6, 2005

(54) Hot melt adhesive system with ultrasonic filter and filtering method

(75) Inventor: John J. Keane, Westlake, OH (US)

Correspondence Address: WOOD, HERRON & EVANS, LLP (NORDSON), 2700 CAREW TOWER, 441 VINE STREET, CINCINNATI, OH, 45202, US

(73) Assignee: Nordson Corporation, Westlake, OH (US)

(21) Appl. No.: 10/812,658

(22) Filed: Mar. 30, 2004

(51) Int. Cl. C07F 1/00

(52) U.S. Cl. 210/435; 210/192

(57) ABSTRACT

A liquid dispensing apparatus includes a manifold and an ultrasonic transducer. The manifold, itself, includes a liquid inlet, a liquid outlet, and a liquid passageway communicating with the liquid inlet and liquid outlet. Additionally, the ultrasonic transducer includes at least a portion that is located within the liquid passageway. The ultrasonic transducer can therefore apply ultrasonic energy on liquid that is traveling through the liquid passageway. The liquid dispensing apparatus can also include a filter located within the liquid passageway and the ultrasonic transducer is positioned to apply the ultrasonic energy before the liquid reaches the filter. In operation, ultrasonic energy is applied to a liquid stream to disintegrate particulate contaminants before they reach a dispensing orifice.

### FIELD OF THE INVENTION

The present invention relates to liquid dispensing systems, and more particularly, with filtering a liquid such as a hot melt adhesive, paint, or other material which may have contaminants, before dispensing the liquid from a discharge orifice.

### BACKGROUND OF THE INVENTION

Viscous liquids are applied by dispensers onto a surface of a substrate in a variety of dispensing applications employed in the manufacture of products and product packaging. These viscous liquids include thermoplastic materials such as hot melt adhesives or other materials such as paints, cold glues, sealants, etc. Liquid dispensers utilize pneumatically or electrically actuated valve assemblies for metering a precise quantity of the viscous liquid and discharging the metered amount through a small-diameter dispensing orifice. Many thermoplastic materials exist in a solid form at room or ambient temperature and must be heated to create a flowable viscous liquid. Typically, the solid form of material is placed in a holding tank or melter having heated walls and is melted by heating the solid material above its melting point. The viscous liquid is pumped through a supply conduit to a manifold block. The manifold block has liquid passageways connected in fluid communication with the dispensing orifice of one or more liquid dispensers.

Under certain operating conditions, particles can accumulate in the viscous liquid and cause the liquid dispenser to periodically become clogged and fail or otherwise malfunction. For example, to meet the demand of certain high-capacity dispensing operations, the holding tank must store a substantial volume of the viscous liquid and maintain the stored volume within a desired range of operating temperatures. This prolonged exposure to heat in an oxygen-containing environment may cause at least a portion of the viscous liquid to char, oxidize, or otherwise degrade. These conditions produce solidified, insoluble particles that admix with and contaminate the liquid.

Continuous operation of the liquid dispenser is contingent upon maintaining an unobstructed liquid pathway for the viscous liquid. Particulate contamination in the supply of viscous liquid can disrupt the operation of the liquid dispenser. The dispensing orifice of the liquid dispenser usually defines the maximum tolerable particle size. Particles that lodge in the dispensing orifice can either totally or partially occlude the flow of viscous liquid to the substrate. Particles may also become trapped between the valve and valve seat of the valve assembly and disrupt the metering of precise amounts of viscous liquid. In the past, to ensure that the flow of viscous liquid to the liquid dispenser is uninterrupted and that the desired amount of liquid is administered to the substrate, the liquid passageway of the manifold block typically incorporates a mesh filter element. Viscous liquid flowing through the liquid passageway is directed through the filter element, which has a porosity designed to remove at least the particles of the maximum tolerable size or larger. However, even with a filter present, there appear to be gels, fibers and/or other matter within the hot melt adhesives or other viscous liquids that can pass through the filter yet still cause blockage of the dispensing orifice.

Additionally, when a filter element becomes clogged, the dispensing operation is interrupted to remove the filter element from the manifold block for cleaning or replacement. The downtime of the dispensing operation associated with the removal, replacement and/or cleaning, and reinstallation of the filter element results in lost productivity. If the filter element is difficult to remove or reinstall, the servicing downtime further reduces productivity. Both result in additional downtime and lost productivity.

In the past, the introduction of ultrasonic energy at the point of dispensing a liquid through an orifice has been utilized to assist with the uniform egress of the liquid at the orifice (see for example, U.S. Pat. No. 6,450,417). Such a technique, however, requires sizing the orifice housing so as to accommodate an ultrasonic horn and to duplicate the ultrasonic horn and corresponding assembly in each dispensing orifice if there is more than one. As some non-woven fiber dispensing systems can include nearly a hundred dispensing orifices, such an approach is impractical.

Thus, a need exists for an improved filtering system in a liquid dispensing apparatus that minimizes the amount of particulates that reach and clog a traditional mesh filter and also for an improved filtering system that reduces the amount of particulates that are able to pass through a traditional mesh filter yet still contribute to clogging the dispensing orifice. Furthermore, the improved filter system should integrate easily with existing dispensing apparatus designs without requiring redesign of dispensing orifices or greatly increasing the cost of the dispensing apparatus.

### SUMMARY OF THE INVENTION

Accordingly, aspects of the present invention relate to a liquid dispensing apparatus that includes an inlet for receiving a liquid from a supply source and at least one outlet for dispensing the liquid onto a substrate. The dispensing apparatus further includes an ultrasonic transducer that is located between the inlet and the outlet and that is in fluid communication with the liquid so as to apply ultrasonic energy to the liquid.

Another aspect of the present invention relates to a liquid dispensing apparatus that includes a manifold and an ultrasonic transducer which acts as a filter in as much as particulate matter is prevented from clogging a downstream dispensing orifice. However, unlike a conventional filter, the ultrasonic energy breaks apart the particulate matter into small enough particles that will pass through the dispensing orifice. The manifold includes a liquid inlet, a liquid outlet, and a liquid passageway communicating with the liquid inlet and liquid outlet. Additionally, the ultrasonic transducer includes at least a portion that is located within the liquid passageway. The ultrasonic transducer can therefore apply ultrasonic energy on fluid that is traveling through the liquid passageway. The liquid dispensing apparatus can also include a mesh filter located within the liquid passageway as well. The manifold may, for example, be a gun manifold or may be another manifold such as one that is associated with a melter or supply tank.

Another aspect of the present invention relates to a manifold for distributing a liquid. In accordance with this aspect, the manifold includes a manifold body having a liquid inlet and a liquid outlet along with a liquid passageway communicating between the inlet and outlet. Additionally, the manifold includes an ultrasonic transducer with at least a portion located within the liquid passageway such that the ultrasonic transducer is configured to apply ultrasonic energy to fluid within the liquid passageway. The application of ultrasonic energy acts to disintegrate contaminants within the fluid or reduce the size of contaminants within the fluid. The fluid within the passageway may, for example, be hot melt liquid adhesive or some other liquid such as paint or ink.

Another aspect of the present invention relates to a method of filtering liquid supplied from a manifold to a dispensing orifice. In accordance with this aspect, a liquid, such as hot melt adhesive, that is received at an inlet port of the manifold is directed from the inlet port to an outlet port of the manifold. Ultrasonic energy is applied to the liquid upstream of the outlet port, either within the manifold or at some other location upstream of the manifold. The application of ultrasonic energy acts to disintegrate contaminants within the liquid or reduce the size of contaminants within the liquid, or both.

These and other features, objects and advantages of the invention will become more readily apparent to those of ordinary skill in the art upon review of the following detailed description, taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 illustrates a schematic view of a liquid dispensing system in accordance with an embodiment of the present invention.

FIG. 2 illustrates a detailed view of a gun manifold having an ultrasonic transducer or filter in accordance with an embodiment of the present invention.

### DETAILED DESCRIPTION

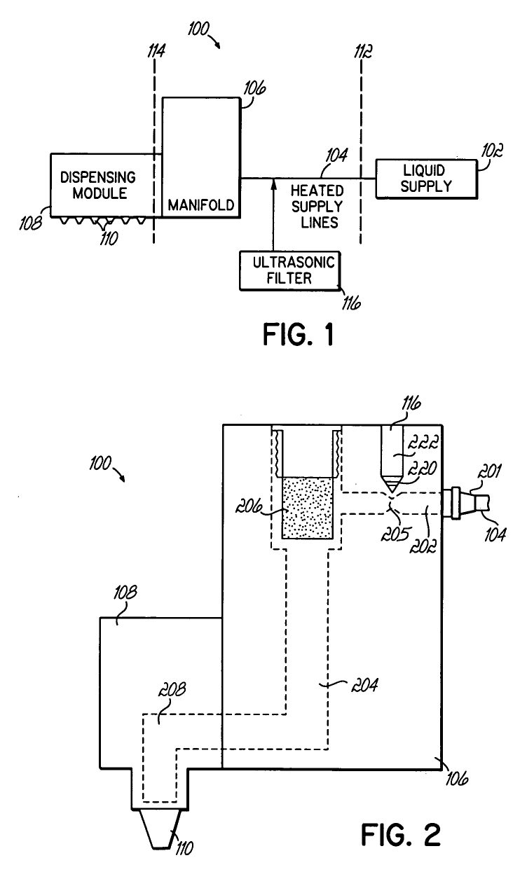

Referring to FIG. 1, a liquid dispensing apparatus 100 is shown, such as a hot melt adhesive dispensing system, that receives liquid from a supply tank 102 or similar source. Supply tank 102 may be a part of a melter which converts a solid or semi-solid form of the adhesive to a heated, molten liquid and pumps the liquefied adhesive under pressure through the supply lines 104 toward a dispensing gun manifold 106. This melter may include manifolds, pumps and supply lines to accomplish its functions. Alternatively, the supply 102 may include a heat exchanger for converting a liquid polymer formulation that becomes a holt melt with the addition of heat and/or mixing. One example of such a liquid is described in Published Patent Application U.S. 2004/0029980A1. Therefore, the supply tank 102 may also include either dynamic, or static, mixing elements. Accordingly, hot melt liquids referred to herein may encompass both conventional hot melt liquids or liquid polymer formulations. As depicted in FIG. 1, the supply lines 104 are typically heated so that the viscous liquid remains in its molten state while traveling to the manifold 106. It will be appreciated that other hot melt adhesive dispensing systems may incorporate the inventive principles, including liquid systems that do not require a melter. Moreover, the invention is applicable to other liquid dispensing systems in which it would be beneficial to filter, or reduce the size of, contaminants before they reach a downstream dispenser such as, for example, paints and inks.

Upon reaching the manifold 106, the viscous liquid is directed towards a dispensing module 108, connected thereto, and ultimately to the dispensing orifices 110. As understood by one of ordinary skill, the internal configuration of the manifold 106 and dispensing module 108 can vary for different liquid dispensing applications. These components can include process air passageways as well as actuating air passages used to actuate a pneumatic valve to open or close an orifice 110 in a controlled manner.

The molten liquid can sometimes char, or oxidize, and form particulates, and/or outside contaminants may be present that will clog the dispensing orifices 110. One approach to removing these particulates is to place a traditional mesh filter between the output of the supply tank 102 and the inlet of the dispensing module 108. In some applications, multiple mesh filters are employed throughout the apparatus 100 generally between points 112 and 114. While generally effective at preventing the dispensing orifices 110 from clogging, even with mesh filters being present dispensing orifices 110 can still become clogged.

Therefore, an ultrasonic filter or transducer 116 is introduced along the liquid path as an alternative, or additional, technique for removing the undesirable particulates from the liquid path. In FIG. 1, the ultrasonic filter 116 is depicted as being located where the heated supply lines 104 enter the upstream side of the manifold 106. This location is exemplary in nature and embodiments of the present invention contemplate locating the ultrasonic filter 116 anywhere between the supply tank 102 and the one or more dispensing orifices 110. For example, the ultrasonic filter 116 may be located in a manifold associated with a melter for the supply tank 102 or located in the dispensing manifold 106.

The closer the ultrasonic filter 116 is located to the dispensing orifices 110, the more likely that the ultrasonic filter 116 will be able to filter particulates that are introduced or created anywhere along the liquid path. However, the ultrasonic filter 116 is preferably located upstream of the module 108.

Thus, even though one or more ultrasonic filters 116 can be located at different locations between the dispensing orifices 110 and the supply tank 102, one suitable location for the ultrasonic filter 116 is within the manifold 106. This location is upstream of the dispensing orifices 110 so that one ultrasonic filter 116 can filter liquid flowing to all of the dispensing orifices 110. Additionally, in this location, the ultrasonic filter 116 is downstream of the supply tank 102 and can, therefore, remove the char and related particular formed during the melting process as well as downstream therefrom. In addition to char, gels and fibers can also be broken apart by the ultrasonic filter 116.

FIG. 2 depicts a more detailed view of a gun manifold 106 in which an ultrasonic filter 116 is located within the manifold 106 in communication with a liquid flow path 202. The manifold 106 includes a coupling 201 that attaches with the supply lines 104 to supply viscous liquid into the manifold 106. Within the manifold are liquid passageways 202 and 204 that communicate liquid from the coupling 201 to the dispensing module 108. As is known in the art, the dispensing module 108 is connected to the manifold 106 so that a liquid passageway 208 in the module 108 communicates with the liquid passageway 204 of the manifold. Ultimately, the liquid leaves the passageway 208 of the module 108 via the dispensing orifice 110. The particular manifold 106 depicted in FIG. 2 includes a mesh filter 206 that separates the liquid passageway 202 from 204. Embodiments of the present invention contemplate using an ultrasonic filter 116 in conjunction with the mesh filter 206 or as a replacement for the mesh filter 206.

When used in conjunction with a mesh filter 206, the ultrasonic filter 116 can either be placed upstream of the mesh filter 206 as depicted in FIG. 2 or, alternatively, downstream of the mesh filter 206 closer to the dispensing module 108. In the upstream position, the ultrasonic filter reduces the number and size of the particulates that reach the filter 206. Furthermore, because the filter 206 may act as a dam that traps particles, the ultrasonic filter 116 may be placed within the filter basket area or close enough to the filter 206 to break up the particles trapped in the filter 206.

The placement of the ultrasonic filter 116 in relation to the liquid passageway 202 is such that a region 205 is created where ultrasonic energy is directed and where the liquid must pass through. The liquid passageway 202 can be restricted at the region 205, as shown, so that the liquid is channeled through a relatively strong ultrasonic energy field. As the liquid passes through the region 205, the char particulates as well as other gels and fibers are disintegrated or at least reduced in size. Thus, these contaminants are ultrasonically filtered from the liquid so as not to clog either the mesh filer 206 or the dispensing orifice 110. Accordingly, the ultrasonic filter 116 acts so as to filter the passing liquid by reducing the number of contaminants through disintegration of some particulates and by reducing the size of other particulates. As a result, less clogging of the dispensing orifice 110 is encountered.

Typically, the ultrasonic filter 116 includes an ultrasonic horn 220 that is located within the passageway 202 and upon excitation by ultrasonic energy is adapted to apply ultrasonic energy to the liquid at region 205. The ultrasonic filter 116 includes an excitation device 222 such as a piezoelectric transducer or a magnetostrictive transducer coupled to the horn 220 along its longitudinal axis. The coupling may be direct or through an elongated waveguide. Applying an excitation frequency of between 15 kHz to 500 kHz will result in the horn 220 vibrating and focusing the ultrasonic energy at the region 205. Various alternative techniques for implementing an ultrasonic transducer or horn are also within the scope of the present invention.

An exemplary environment in which a liquid dispenser may include an ultrasonic filter 116, as described herein, is in the production of diapers or other non-woven items. In such an environment, the coating head of the liquid dispenser delivers multiple streams of adhesive through a plurality of dispensing orifices 110. In particular, a diaper manufacturing line operates at 300-400 diapers per minute and, at this rate, a human cannot detect if one of the dispensing orifices 110 has become clogged. Accordingly, the ultrasonic filter 116 is particularly advantageous in this environment. Within this specific environment, an ultrasonic filter operating between 15 kHz and 500 kHz is effective to reduce the number and the size of contaminants in hot melt pressure sensitive adhesive that is at a temperature around 350° F. and a pressure of around 500-1200 psi as evidenced by the observation of reduced clogging of the dispensing orifices 110.

While the present invention has been illustrated by a description of various preferred embodiments and while these embodiments has been described in some detail, it is not the intention of the Applicant to restrict or in any way limit the scope of the appended claims to such detail. Additional advantages and modifications will readily appear to those skilled in the art. The various features of the invention may be used alone or in numerous combinations depending on the needs and preferences of the user. This has been a description of the present invention, along with the preferred methods of practicing the present invention as currently known.

1. A liquid dispensing apparatus comprising:
a manifold having a liquid inlet and a liquid outlet;
a liquid passageway communicating with said liquid inlet and said liquid outlet; and
an ultrasonic transducer with at least a portion located within said liquid passageway upstream of said liquid outlet and configured to apply ultrasonic energy to a fluid within said liquid passageway.

2. The apparatus of claim 1 further comprising:
a liquid dispenser having a liquid inlet coupled in fluid communication with said liquid outlet of said manifold.

3. The liquid dispensing apparatus of claim 1, wherein application of said ultrasonic energy to said fluid reduces contaminants suspended within said fluid.

4. The liquid dispensing apparatus of claim 1, wherein application of said ultrasonic energy to said fluid reduces a size of one or more contaminants suspended within said fluid.

5. The liquid dispensing apparatus of claim 1, wherein application of said ultrasonic energy to said fluid disintegrates one or more contaminants suspended within said fluid.

6. The liquid dispensing apparatus of claim 1, further comprising:
a mesh filter located within said liquid passageway.

7. The liquid dispensing apparatus of claim 6, wherein said ultrasonic transducer is located within a housing for said mesh filter.

8. The liquid dispensing apparatus of claim 6, wherein said ultrasonic transducer is located proximate to said mesh filter such that application of said ultrasonic energy reduces contaminants located within said mesh filter.

9. The liquid dispensing apparatus of claim 6, wherein said mesh filter is located downstream of said portion of said ultrasonic transducer.

10. The liquid dispensing apparatus of claim 1, wherein said portion is located in said manifold between said liquid inlet and said liquid outlet.

11. The liquid dispensing apparatus of claim 1, wherein the liquid passageway further comprises:
a restricted orifice; and
wherein said portion is positioned to direct said ultrasonic energy at the restricted orifice.

12. The liquid dispensing apparatus of claim 1, wherein the ultrasonic transducer operates at a frequency between substantially 15 kHz and 500 kHz.

13. A liquid dispensing apparatus comprising:
an inlet for receiving a liquid from a source;
at least one outlet for dispensing said liquid onto a substrate;
an ultrasonic transducer disposed between said inlet and said outlet, in fluid communication with said liquid for applying ultrasonic energy to said liquid.

14. A method of filtering liquid supplied to a dispensing orifice comprising the steps of:
directing the liquid from a liquid supply to a passageway communicating with a liquid inlet and a liquid outlet, the liquid outlet upstream of the dispensing orifice; and
applying ultrasonic energy to the liquid upstream of the liquid outlet so as to filter the liquid.

15. The method of claim 14, further comprising the steps of:
restricting a flow of the liquid at an orifice located in the passageway; and
applying the ultrasonic energy at the orifice.

16. The method of claim 14, further comprising the step of:
applying the ultrasonic energy in a frequency between substantially 15 kHz and 500 kHz.

17. The method of claim 14, further comprising the step of:
filtering the liquid using a mesh filter.

18. The method of claim 17, wherein the mesh filter is located downstream of a location at which the ultrasonic energy is applied.

19. The method of claim 18, wherein applying ultrasonic energy further includes the step of:
reducing contaminants located within the mesh filter.

20. The method of claim 14, wherein the liquid is a hot melt adhesive.

21. The method of claim 14, wherein the liquid is an ink.

22. The method of claim 14, wherein the liquid is a paint.
